(19) United States
(12) Patent Application Publication
(10) Pub. No.: US 2017/0220225 A1
(43) Pub. Date: Aug. 3, 2017

(54) A METHOD AND SYSTEM FOR PROVIDING INTERACTIVITY WITHIN A VIRTUAL ENVIRONMENT

(71) Applicant: APELAB SARL, Geneva (CH)

(72) Inventors: Emilie JOLY, Nyon (CH); Sylvain JOLY, Nyon (CH)

(21) Appl. No.: 15/315,956

(22) PCT Filed: Jun. 2, 2015
(86) PCT No.: PCT/EP2015/062307

§ 371 Date: Dec. 2, 2016

Related U.S. Application Data
(60) Provisional application No. 62/006,727, filed on Jun. 2, 2014.

(51) Int. Cl. G06F 3/0481; G06F 3/01; G06T 15/20; G06F 3/16

(52) U.S. Cl. CPC G06F 3/04815; G06F 3/167; G06F 3/016; G06T 15/20; G06F 3/165; G06F 3/012

(57) ABSTRACT

The present invention relates to a method of providing interactivity within a virtual environment displayed on a device. The method includes the steps of receiving input from a user to orient a virtual camera within the virtual environment, wherein the virtual environment comprises a plurality of objects and wherein at least some of the objects are tagged; and triggering one or more actions associated with the tagged objects when the tagged objects are within a defined visual scope of the virtual camera. A system and computer program code are also disclosed.

### FIELD OF INVENTION

The present invention is in the field of virtual environments. More particularly, but not exclusively, the present invention relates to interactivity within virtual environments.

### BACKGROUND

Computing systems provide different types of visualisation systems. One visualisation system that is used is the virtual environment. A virtual environment displays to a user a view from a virtual camera oriented within the virtual environment. Input is received from the user to change the orientation of the virtual camera.

Virtual environments are used in a number of fields including entertainment, education, medical, and scientific.

The technology for displaying the virtual environment can include desktop/laptop computers, portable devices such as tablets and smartphones, and virtual reality headsets such as Oculus Rift™.

For some portable devices with internal gyroscopes, the user can orient the virtual camera by moving the portable device and the portable device uses its orientation derived from its gyroscope to position the virtual camera within the virtual environment.

The user orients the virtual camera in virtual reality headsets by turning and tilting their head.

One such virtual environment is provided by Google Spotlight Stories™. The Spotlight Stories™ are 360 degree animated films provided for smartphones. The user can orient the virtual camera within the virtual environment by moving their smartphone. Via the internal gyroscope, the smart-phone converts the orientation of the smart-phone into the orientation of the virtual camera. The user can then view the linear animation from a perspective that they choose and can change perspective during the animation.

For some applications it would be desirable to enable interactivity within the virtual environments. Interactivity is typically provided via a touchpad or pointing device (e.g. a mouse) for desktop/laptop computers, via a touch-screen for handheld devices, and via buttons on a virtual reality headset.

The nature and applications of the interactivity provided by the prior art can be limited in the different types interactive experiences that can be provided via the use of virtual environments. For example, the user must consciously trigger the interaction by providing a specific input and the user interface for receiving inputs for handheld devices and virtual reality headsets can be cumbersome—fingers on touch-screens block a portion of the display for handheld devices and the user can't seen the buttons they must press in virtual reality headsets.

There is a desire, therefore, for an improved method and system for providing interactivity within virtual environments.

It is an object of the present invention to provide a method and system for providing interactivity within virtual environments which overcomes the disadvantages of the prior art, or at least provides a useful alternative.

### SUMMARY OF INVENTION

According to a first aspect of the invention there is provided a method of providing interactivity within a virtual environment displayed on a device, including:

Receiving input from a user to orient a virtual camera within the virtual environment, wherein the virtual environment comprises a plurality of objects and wherein at least some of the objects are tagged; and

Triggering one or more actions associated with the tagged objects when the tagged objects are within a defined visual scope of the virtual camera.

According to a further aspect of the invention there is provided a system for providing interactivity within a virtual environment, including:

A memory configured for storing data for defining the virtual environment which comprises a plurality of objects, wherein at least some of the objects are tagged;

An input means configured for receiving input from a user to orient a virtual camera within the virtual environment;

A display configured for displaying a view from the virtual camera to the user; and

A processor configured for orienting the virtual camera in accordance with the input and for triggering one or more actions associated with tagged objects within the visual scope of the virtual camera.

According to a further aspect of the invention there is provided a computer program code for providing interactivity within a virtual environment, including: A generation module configured, when executed, to generate a plurality of tagged objects within a virtual environment and to associate one or more actions with each tagged object; and

A trigger module configured, when executed, to generate a projection from a virtual camera into the virtual environment, to detect intersections between the projection and visible tagged objects, and to trigger actions associated with the intersected tagged objects.

According to a further aspect of the invention there is provided a system for providing interactivity within a virtual environment, including:

A memory configured for storing a generation module, a trigger module, and data for defining a virtual environment comprising a plurality of objects;

A user input configured for receiving input from an application developer to create a plurality of tagged objects and one or more actions associated with each tagged object within the virtual environment; and

A processor configured for executing the generation module to create a plurality of tagged objects and one or more actions associated with each tagged object within the virtual environment and for compiling an application program incorporating the trigger module.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a flow diagram illustrating a method in accordance with an embodiment of the invention;

FIG. 3: shows a block diagram illustrating computer program code in accordance with an embodiment of the invention;

FIG. 4: shows a block diagram illustrating a system in accordance with an embodiment of the invention;

FIGS. 5a to 5c: show block diagrams illustrating a method in accordance with different embodiments of the invention; and

FIG. 6: shows a flow diagram illustrating a method in accordance with an embodiment of the invention;

FIG. 7a: shows a diagram illustrating orientating a physical device with respect to a virtual environment in accordance with an embodiment of the invention;

FIG. 7b: shows a diagram illustrating orientating a virtual camera within a virtual scene in accordance with an embodiment of the invention;

FIG. 7c: shows a diagram illustrating a user orientating a tablet device in accordance with an embodiment of the invention;

FIG. 7d: shows a diagram illustrating a user orientating a virtual reality headset device in accordance with an embodiment of the invention;

FIG. 8a: shows a diagram illustrating triggering of events at “GazeObjects” in accordance with an embodiment of the invention;

FIGS. 8b to 8d: show diagrams illustrating triggering of events at “GazeObjects” within a proximity zone in accordance with an embodiment of the invention;

FIG. 9: shows a flow diagram illustrating a trigger method in accordance with an embodiment of the invention;

FIG. 10a: shows a diagram illustrating different events triggered in accordance with an embodiment of the invention;

FIG. 10b: shows a diagram illustrating a “gazed” object triggering events elsewhere in a virtual scene in accordance with an embodiment of the invention;

FIG. 11: shows a diagram illustrating spatialised sound in accordance with an embodiment of the invention; and

FIG. 12: shows a tablet and head-phones for use with an embodiment of the invention.

### DETAILED DESCRIPTION OF PREFERRED EMBODIMENTS

The present invention provides a method and system for providing interactivity within a virtual environment.

The inventors have discovered that the orientation of virtual camera by the user within a virtual 3D environment approximates the user's gaze and, therefore, their interest within that virtual space. Based upon this, the inventors realised that this “gaze” alone could be used to trigger actions tied to “gazed” objects within the virtual environment. This “gaze”-enabled environment provides or augments interactivity. The inventors have discovered that it may be particularly useful in delivering interaction narrative experiences in 3D virtual worlds, because the experience can be scripted but triggered by the user.

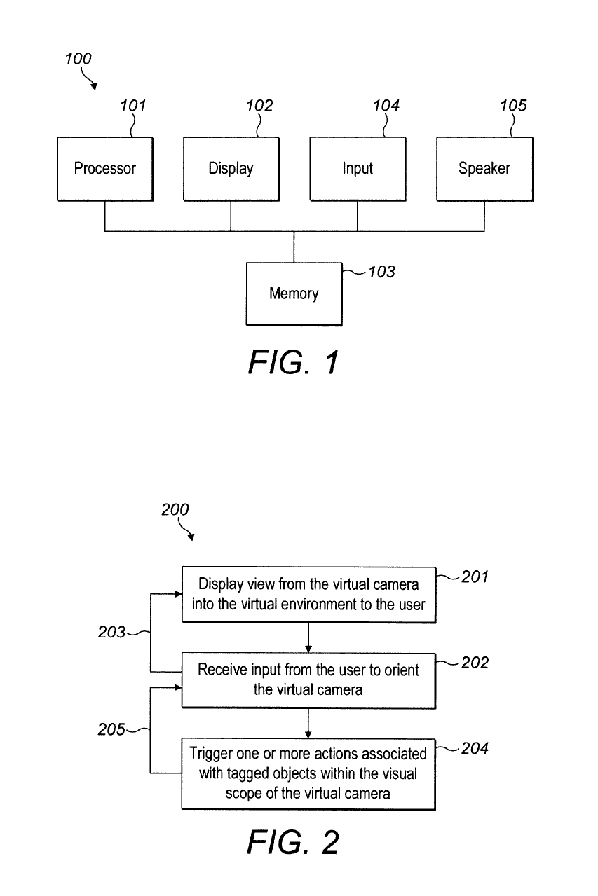

In FIG. 1, a system 100 in accordance with an embodiment of the invention is shown.

The system 100 includes a display 101, an input 102, a processor 103, and a memory 104.

The system 100 may also include an audio output 105. The audio output 105 may be a multi-channel audio output such stereo speakers or headphones, or a surround sound system.

The display 101 may be configured to display a virtual environment from the perspective of a virtual camera. The display 101 may be, for example, a LED/LCD display, a touch-screen on a portable device or a dual left eye-right eye display for a virtual reality headset.

The input 102 may be configured to receive input from a user to orient the virtual camera within the virtual environment. The input 102 may be, for example, one or more of a gyroscope, compass, and/or accelerometer.

The virtual environment may include a plurality of objects. Some of the objects may be tagged and associated with one or more actions.

The processor 103 may be configured to generate the view for the virtual camera for display to the user, to receive and process the input to orient the virtual camera within the virtual environment, and to trigger the one or more actions associated with tagged objects that are within a visual scope for the virtual camera.

The actions may be visual or audio changes within the virtual environment, other user outputs via the display 101, audio output 105, or any other type of user output (e.g. vibration via a vibration motor); activity at another device; or network activity.

The actions may relate to the tagged object, to other objects within the virtual environment, or not to any objects.

The visual scope may be the entire view of the virtual camera or a view created by a projection from the virtual camera. The projection may be a ray or another type of the projection (e.g. a cone). The projection may be directed out of the centre of the virtual camera and into the virtual environment.

The memory 104 may be configured to store data defining the virtual environment including the plurality of objects, data identifying which of the objects are tagged, data mapping actions to tagged objects, and data defining the actions.

The display 101, input 102, memory 104, and audio output 105 may be connected to the processor 103 independently, in combination or via a communications bus.

The system 100 is preferably a personal user device such as a desktop/laptop computer, a portable computing device such as a tablet, smartphone, or smartwatch, a virtual reality headset, or a custom-built device. It will be appreciated that the system 100 may be distributed across a plurality of apparatus linked via one or more communications systems. For example, the display 101 and input 102 may be a part of a virtual reality headset linked via a communications network (e.g. wifi or Bluetooth) to the processor 103 and memory 104 within a computing apparatus, such as a tablet or smartphone.

In one embodiment, the portable computing device may be held in place relative to the user via a headset such as Google Cardboard™, Samsung Gear™, or HTC Vive™.

Where the input 102 and display 101 form part of a portable computing device and where the input 102 is one or more of a gyroscope, compass and/or accelerometer, movement of the entire device may, therefore, orient the virtual camera within the virtual environment. The input 102 may be directly related to the orientation of the virtual camera such that orientation of the device corresponds one-to-one with orientation of the virtual camera.

Referring to FIG. 2, a method 200 in accordance with an embodiment of the invention will be described.

The method 200 may utilise a virtual environment defined or created, at least in part, by one or more application developers using, for example, a virtual environment development platform such as Unity. During creation of the virtual environment, the application developer may create or define tagged objects, and associate one or more actions with each of these tagged objects.

In some embodiments, the tagged objects and/or associated actions may be generated, wholly or in part, programmatically and in response to input from the application developer or, in one embodiment, dynamically during interaction with the virtual environment by the user, or in another embodiment, in response to input from one or more parties other the user.

The virtual environment may be comprised of one or more scenes. Scenes may be composed of a plurality of objects arranged within a 3D space.

Scenes may be defined with an initial virtual camera orientation and may include limitations on the re-orientation of the virtual camera (for example, only rotational movement, or only horizontal movement, etc.) Objects within a scene may be static (i.e. the state or position of the object does not change) or dynamic (e.g. the object may undergo animation or translation within the 3D space). Scripts or rules may define modifications to the objects.

In step 201, a view from the virtual camera into the virtual environment is displayed to a user (e.g. on the display 101). The view may include the display of, at least part of, one or more objects that are “visible” to the virtual camera. An object may be delimited within the virtual environment by boundaries. The boundaries may define a 3D object within the virtual environment. The boundaries may be static or dynamic. A “visible” object may be an object that intersects with projections from the virtual camera into the virtual environment.

In step 202, the user provides input (e.g. via the input 102) to orientate the virtual camera within the virtual environment. Re-orientating the virtual camera may change the view that is displayed to user as indicated by step 203.

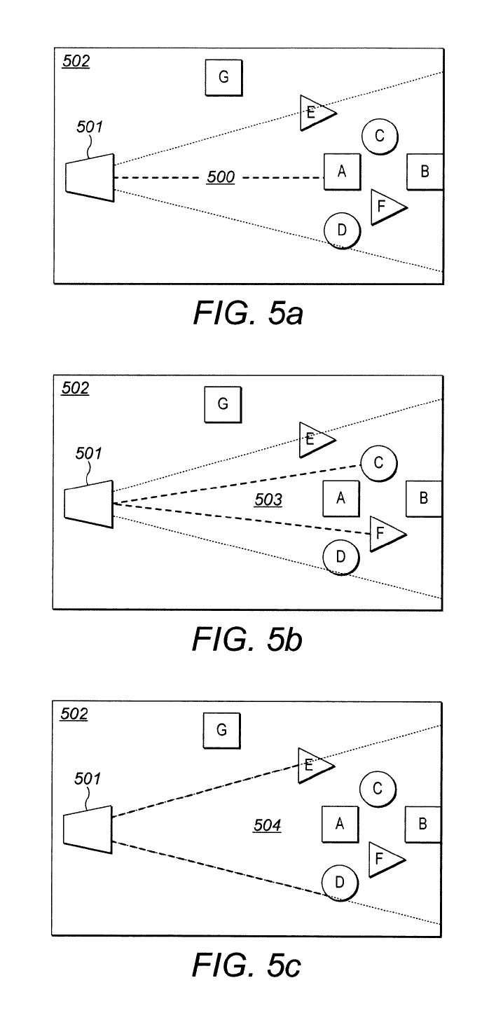

In step 204, one or more actions associated with tagged objects within a defined visual scope of the virtual camera are triggered (e.g. by the processor 103). The visual scope may be defined as one of a plurality of views formed by projections from the virtual camera. Examples of different projections are shown in FIGS. 5a to 5c and may include a ray projecting from the virtual camera into the virtual environment; a cone projecting from the virtual camera into the environment; or the entire view of the virtual camera (e.g. a rectangular projection of the dimensions of the view displayed to the user projected into the virtual environment). Further input may then be received from the user as indicated by step 205.

A defined trigger time period may be associated with the actions, tagged objects, or globally. The one or more action may be triggered when the tagged objects are within the defined visual scope for the entirety of the defined time period. It will be appreciated that alternative implementations for a trigger time period are possible. For example, the tagged object may be permitted periods under a threshold outside the visual scope within resetting the trigger time period, or the tagged object may accumulate the trigger time period by repeated occurrences within the visual scope.

The actions may manifest one or more of the following occurrences:
a) Visual changes, such as animation of objects (for example, sprite animations, skeletal animation, 3D animation, particle animation), animation within the visual environment (such as weather animation), or other visual modifications (such as brightening/darkening the view, or changing the appearance of user interface elements).
b) Audio changes, such as playback or cessation of specific/all audio tracks, ducking of specific audio tracks and other volume changes to specific/all audio tracks, etc.
c) Programmatic changes, such as adding, removing, or otherwise modifying user interface functionality;
d) Any other user output, such as vibration
e) Network messages (for example, wifi or Bluetooth messages to locally connected devices or Internet messages to servers);
f) Messages to other applications executing on the device;
g) Modification of data at the device;
h) Perspective change (for example, the virtual camera may jump to another position and orientation within the scene, or the entire scene may change); and
i) Selection of a branch within a script defined for the scene or modification of the script defined for the scene (for example, where a branching narrative has been defined for the virtual environment, one branch may be activated or selected over the other(s)).

The occurrences may relate to the tagged object associated with the action, other objects within the scene, or objects within another scene.

In some embodiments, when the actions manifest audio changes, at least some of the audio changes may be localised within 3D space, such that user may identify that the audio appears to be originating from a specific object within the virtual environment. The specific objects may be the tagged object. The audio may change in volume based upon whether the tagged object is within the defined visual scope (e.g. the volume may reduce when the tagged object is outside the defined visual scope).

In some embodiments, the actions associated with tagged objects may also be triggered by other factors without falling within the visual scope. For example, by a count-down timer initiated by the start of the scene, triggering of another action, receipt of a network signal, receipt of another input, and/or occurrence of an event relating to the virtual environment (e.g. specific audio playback conditions, display conditions, etc).

A defined delay time period may be associated with the actions, tagged objects, or globally. The one or more actions once triggered may wait until the defined delay time period elapses before manifesting occurrences.

In some embodiments, the one or more actions may be triggered to stop or change when the associated tagged object is no longer within the defined visual scope.

In some embodiments, at least some of the actions may only be triggered once.

In some embodiments, at least some of the actions include additional conditions that must be met to trigger the action. The additional conditions may include one or more of: angle of incidence from the projection into the tagged object, movement of the projection in relation to the tagged object, other device inputs such as camera, humidity sensor, etc., time of day, weather forecast, etc.

In one embodiment, specific actions are associated directly with each tagged object. In an alternative embodiment, the tagged objects may be classified (for example, into classes), and the classes may be associated with specific actions such that all tagged objects of that class are associated with their class's associated actions.

In some embodiments, actions associated with objects are only triggered when the virtual camera is also proximate to the object. Proximity may be defined on a global basis or object/object type specific basis. A proximity threshold for an object may be defined to be met when the virtual camera is within a specified distance to an object or when the virtual camera is within a defined perimeter surrounding an object.

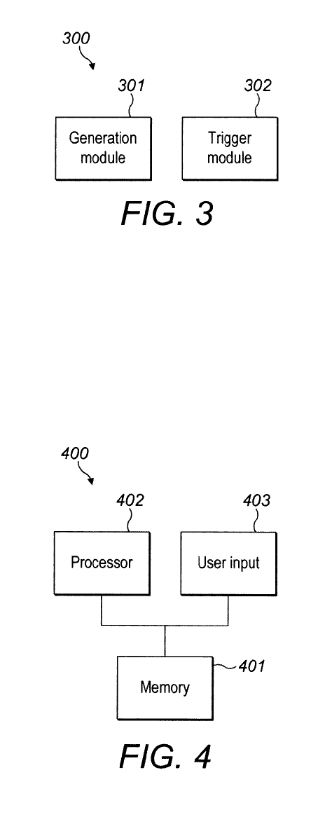

Referring to FIG. 3, computer program code 300 in accordance with an embodiment of the invention will be described.

A generation module 301 is shown. The generation module 301 includes code that when executed on a processor enables creation by an application developer of a plurality of tagged objects for use in a virtual environment, and association of each tagged objects with one or more actions.

A trigger module 302 is shown. The trigger module 302 includes code that when executed on a processor triggers one or more actions associated with tagged objects intersecting with a projection from a virtual camera into the virtual environment.

The computer program code 300 may be stored on non-transitory computer readable medium, such as flash memory or hard drives (e.g. within the device or a server), or transitory computer readable medium, such as dynamic memory, and transmitted via transitory computer readable medium such as communications signals (e.g. across a network from a server to device).

At least part of the computer program code 300 may be compiled into an executable form for deployment to a plurality of user devices. For example, the trigger module 302 may be compiled along with virtual environment generation code and other application code into an executable application for use on a user device.

In FIG. 4, a system 400 in accordance with an embodiment of the invention is shown.

The system 400 includes a memory 401, a processor 402, and a user input 403.

The memory 401 is configured to store the computer program code described in relation to FIG. 3 and a virtual environment development software platform such as Unity. The virtual environment development platform includes the ability to create a plurality of objects within the virtual environment. These objects may be static objects, objects that move within the virtual environment or objects that animate. The objects may be comprised of closed polygons forming a solid shape when displayed, or may include one or more transparent/translucent polygons, or may be visual effects such as volumetric smoke or fog, fire, plasma, water, etc., or may be any other type of object.

An application developer can provide input via the user input 403 to create an interactive virtual environment using the virtual environment development software platform.

The application developer can provide input via the user input 403 to provide information to the generation module to create a plurality of tagged objects and associate one or more actions with the tagged objects.

The processor 402 may be configured to generate computer program code including instructions to: display the virtual environment on a device, receive user input to orient the virtual camera, and trigger one or more actions associated with tagged objects intersecting with a projection from the virtual camera.

FIGS. 5a to 5c illustrate different visual scopes formed by projections in accordance with embodiments of the invention.

FIG. 5a illustrates a visual scope defined by a ray projected from the virtual camera into a virtual environment. The virtual environment includes a plurality of objects A, B, C, D, E, F, and G. Some of the objects are tagged A, C, F, and G. It can be seen that object A falls within the visual scope defined by the projection of the ray, because the ray intersects with object A. If the object is opaque and non-reflective, the projection may end. Therefore, object B is not within the visual scope. Actions associated with A may then be triggered.

FIG. 5b illustrates a visual scope defined by a cone projected from the virtual camera into the virtual environment. It can be seen that object A, C and D fall within the visual scope defined by the projection of the ray. Therefore, actions associated with A and C may be triggered.

FIG. 5c illustrates a visual scope defined by the entire view of the virtual camera. It can be seen that the projection to form the entire view intersects with A, C, D, E and F. Therefore, the actions associated with A, C, and F may be triggered.

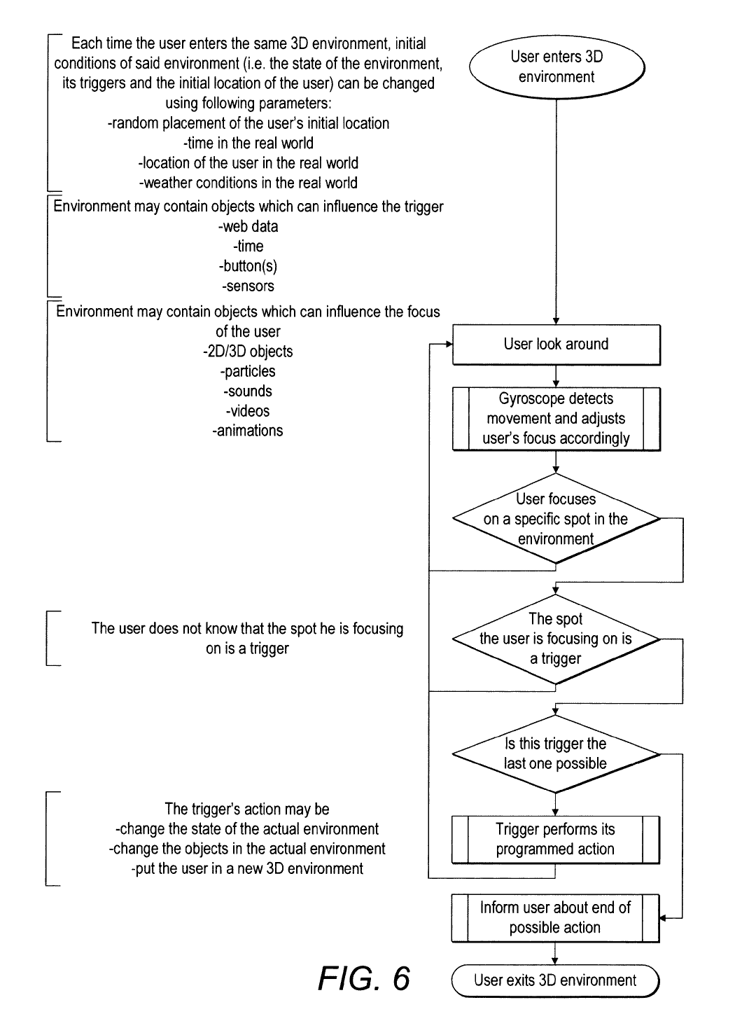

Some embodiments of the invention will now be described with reference to FIGS. 6 to 12. These embodiments of the invention will be referred to as “Gaze”

The Gaze embodiments provide a creation system for interactive experiences using any gyroscopic enabled device such as mobile devices, Virtual Reality helmets and depth tablets. Gaze may also simplify the development and creation of complex triggered based interactive content between the users and the virtual environment.

The Gaze embodiments enable users to trigger several different actions in a virtual environment as shown in FIG. 6 simply by looking at them with the virtual camera. Interactive elements can be triggered based on multiple factors like time, other interactive elements' triggers and objects collisions. The Gaze embodiments may also enable chain reactions to be set up so that when an object is triggered, it can trigger other objects too.

Some of the Gaze embodiments may be deployed within the Unity 3D software environment using some of its internal libraries and graphical user interface (GUI) functionalities. It will be appreciated that alternative 3D software development environments may be used.

Most of the elements of the Gaze embodiments may be directly set up in the standard Unity editor through component properties including checkboxes, text fields or buttons.

### The Camera

The standard camera available in Unity is enhanced with the addition of two scripts of code described below:

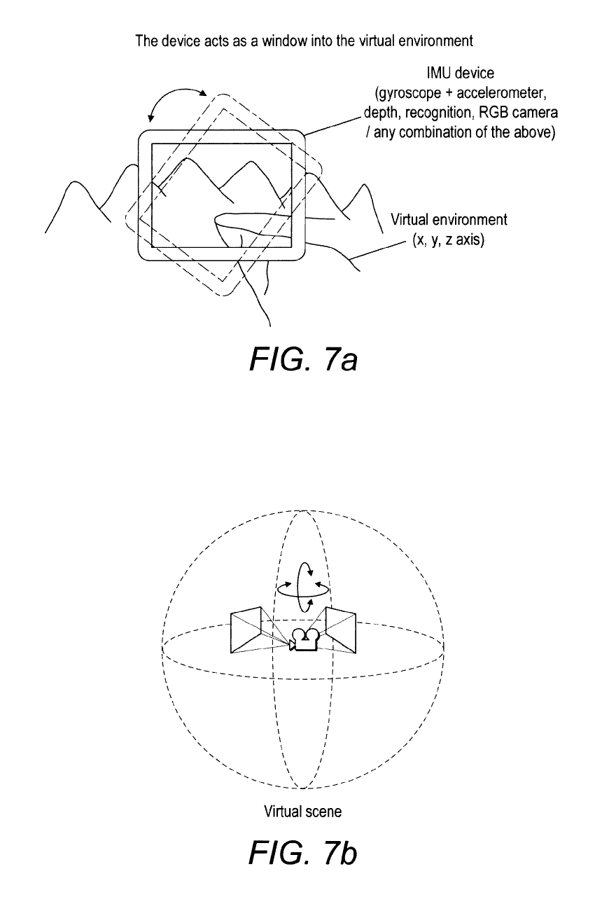

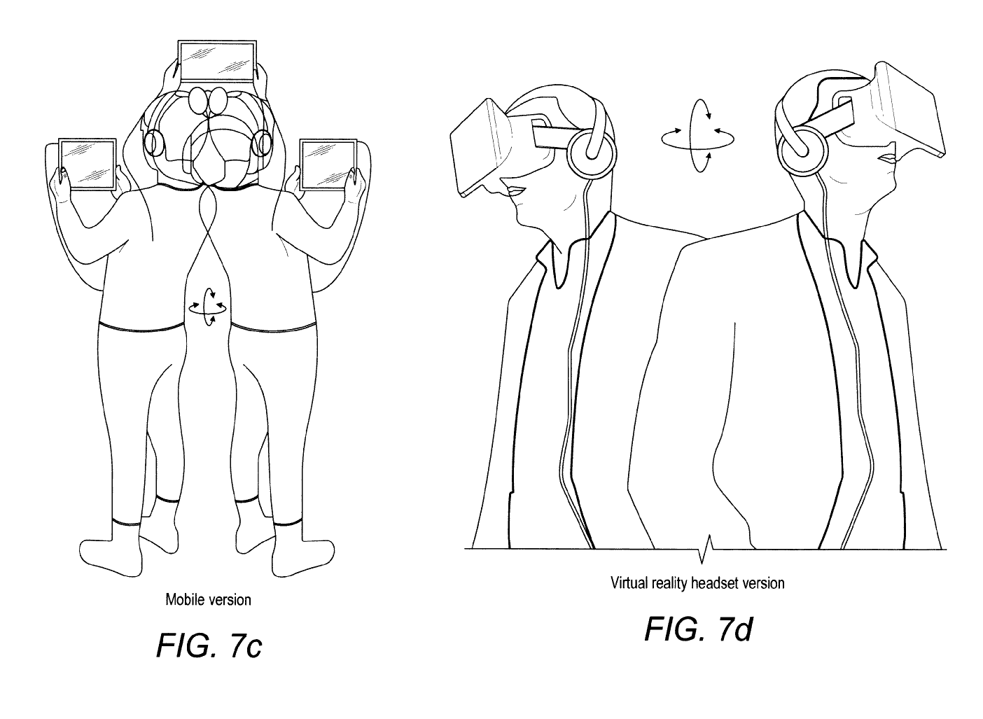

1. The gyro script allows the camera to move accordingly with the movements of the physical device running the application. An example is shown in FIG. 7a where a tablet device is being rotated with respect to a virtual environment. It translates, one to one, the spatial movements, on the three dimensional axis, between the virtual camera and the physical device. Three dimensional movement of the virtual camera within a virtual scene is shown in FIG. 7b.

The devices may include goggle helmets (illustrated in FIG. 7c where movement of the head of a user wearing the helmet translates to the movement shown in FIG. 7b), mobile devices with orienting sensors like tablets (illustrated in FIG. 7d where orientation of the tablet in the physical world translates to movement shown in FIG. 7b) or smartphones or any other system with orientation sensors (e.g. gyroscope, compass).

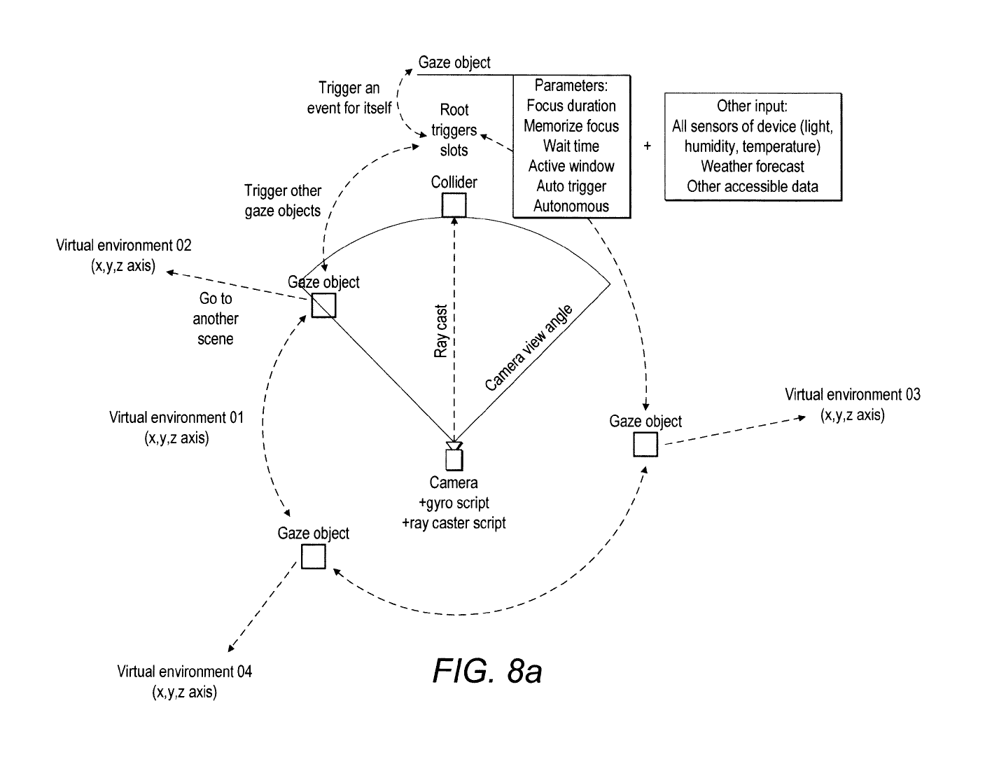

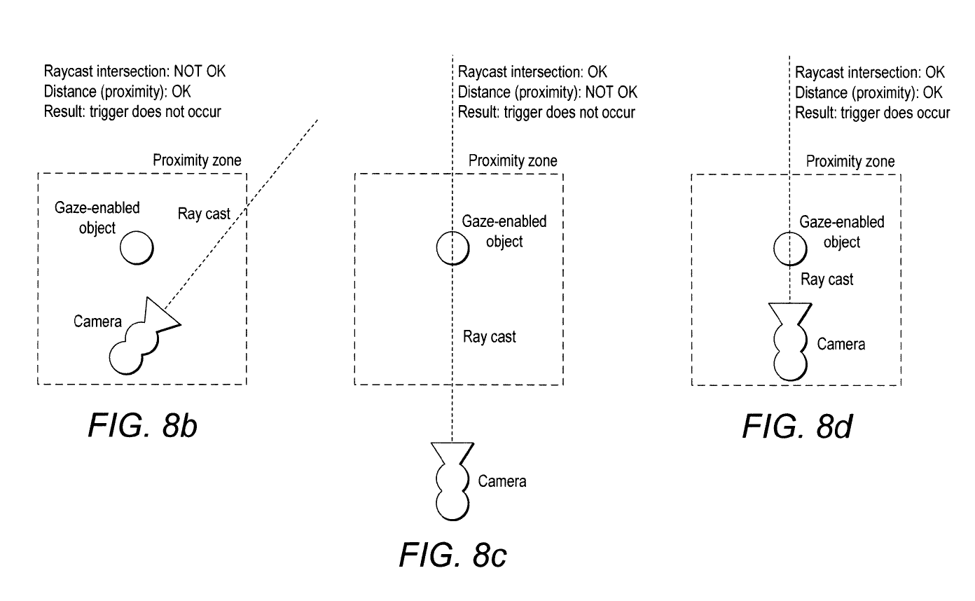

2. The ray caster script allows the camera to be aware of what it is looking at. It fires a ray from the camera straight towards its looking angle. By such, it allows the script to know which object is in front of the camera and directly looked at. Then, the script notifies components interested in knowing such information. An example of the executing ray script is shown in FIG. 8a where a ray cast from the virtual camera collides with a “GazeObject”. The collision triggers events at the GazeObject and events at other GazeObjects in the same and different virtual scenes.

The script has an option to delay the activation of the processes described above by entering a number in a text field in the Unity editor window, representing the time in seconds before the ray is being cast.

The ray may be casted at an infinite distance and be able to detect any number of gaze-able objects it intersects and interact with them.

### Gazable Objects

Every GameObject in Unity can be turned into what will be called a “GazedObject”. That means that every object in the scene view of Unity can potentially be part of the Gaze interaction system. To create a GazedObject, a Unity prefab is created. This object may be dropped in the scene view and contains three distinct parts:

The root—the top element in the hierarchy of the GazedObject. Contains the animator for moving the whole GazedObject prefab in the scene view.

The ‘Triggers’ child—contains every trigger associated with the GazedObject (trigger will be described further). It also contains the collider responsible for notifying when the GazedObject is being gazed by the camera.

The ‘Slots’ child—contains every GameObject associated with the GazedObject (sprite, 3D model, audio . . . ) Each slot added to the ‘Slots’ parent represents one or multiple part of the whole GameObject. For instance, the Slots component of a Human GazedObject could contain 6 children, one for the body, one for each arm, one for each leg and one for the head. The Slots child also has an animator responsible for animating the child components it contains.

### Triggers

The child named Triggers' in the GazedObject prefab contains one or more children. Each child is a trigger itself. A trigger can be fired by one of the following event:
A collision between two GameObject (Collider object in Unity).
A GameObject being gazed by the camera (through the Gaze technology).
A duration in seconds either started from the load of the scene or relative to another Trigger contained in a GazedObject.

The trigger GameObject contains four components; an ‘Audio Source’ component as part of standard Unity, a ‘Trigger Activator’ script, an ‘Audio Player’ script and a custom script. The description of each script follows: The ‘Trigger Activator’ is a script that specifies the time when the trigger child GameObject will be active, and its potential dependencies with other triggers. It displays the following graphical fields to the user to set those different values:

‘Autonomous’ is an editable checkbox to specify if the trigger is dependant on another GazedObject's trigger or if it is autonomous. If the checkbox is checked, the ‘Activation Duration’ and ‘Wait Time’ will be relative from the time set by the start of the Unity scene. If not, they will be dependant on the start time of another GazedObject's trigger.

‘Wait Time’ is an editable text field used to set the desired amount of time in seconds before firing the actions specified in the custom script (described further) from the time when its trigger has been activated.

‘Auto Trigger’ is an option box to specify if the trigger must be fired once it reaches the end of the ‘Activation Duration’ time added to the ‘Wait Time’ defined if checked event if no trigger has occurred (collision, gaze or time related). If not checked, no actions will be taken if no trigger occurred during this time window.

‘Reload’ is an option box that allows the trigger to reset after being triggered so that it can be re-triggered.

‘infinite’ is an option used to specify if the duration of activation is infinite.

‘proximity’ is an option to specify if the camera has to be closer to a specified distance in order to be able to trigger an action. The distance is defined by a collider (invisible cube) in which the camera has to enter to be considered close enough (as shown in FIGS. 8b, 8c, and 8d).

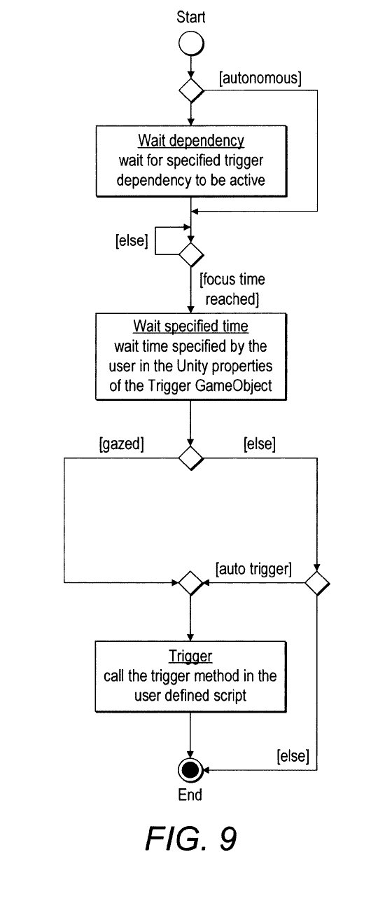

A flow diagram illustrating triggering of events at GazeObjects is shown at FIG. 9.

Interactive experiences in a fully immersive (360° on the three dimensional axis x/y/z) virtual environment with the ability for the user to control the virtual camera has never been made before.

The sound may be also be provided by the Gaze system to help prioritise the audio source in the environment when looked at.

The Gaze embodiments provide the following improvement over the prior art: the user may be unaware of the triggers and these triggers may be activated only by the focus of the user in said environment. Therefore, no physical or virtual joystick is necessary.

The user devices may include devices such as smartphones, a digital tablet, a mobile gaming console, or a virtual reality headset or other devices that are capable of triggering different events by the virtual camera's orientation. Further, the spatial application can be accessed on various operating systems, including iOS, Mac, Android and Windows.

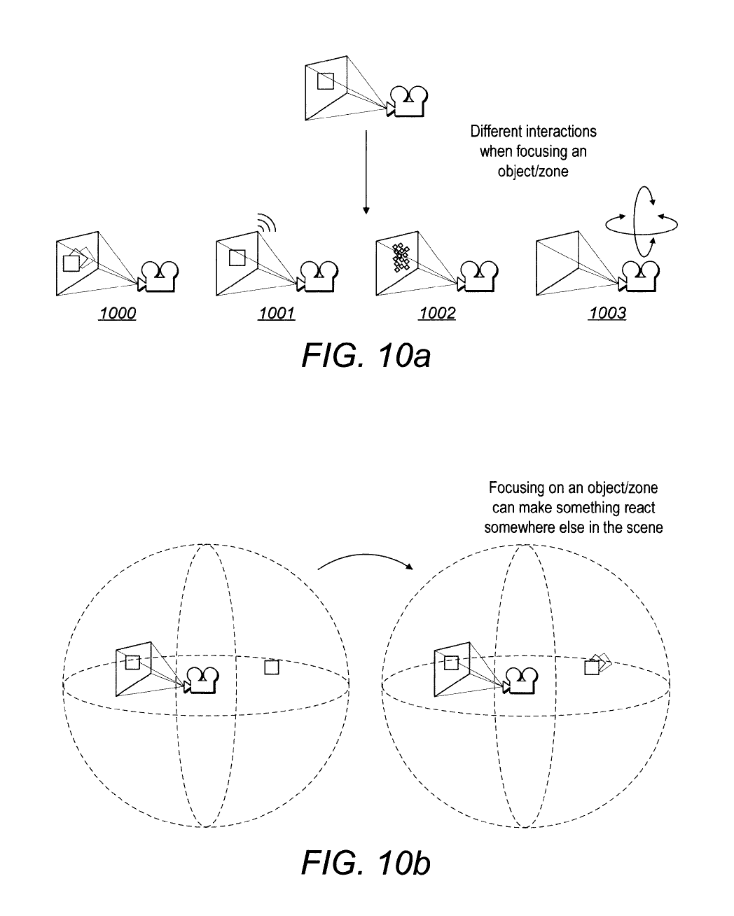

In one or more embodiments, the system allows the user to navigate with a virtual camera within a 3D environment using a gyroscopic enable device (e.g: a smartphones, a digital tablet, a mobile gaming console, or a virtual reality headset) and triggering different events by the virtual camera's orientation, either intentionally or unintentionally by the user. By way of example, the device's screen may include an image of the virtual world. Moreover, the virtual camera may cast a ray, which serves as a possible trigger for all elements in the virtual world. In one embodiment, once this ray strikes an element in the virtual world, different type of events can be activated as shown in FIG. 10a, for instance: animations (this includes any kind of transformation of an existing element 1000 in the virtual world or any new element), sounds 1001, video, scenes, particle systems 1002, sprites animation, change in orientation 1003 or any other trigger-able element.

More specifically, these events can be located not only in the ray's field, but in any other angle of its scenes or another as shown in FIG. 10b. In particular, each event can be triggered by a combination of any of the following conditions: the ray's angle, a time window in which the event can be activated, the duration if a ray's particular angle, the ray's movements, the device's various inputs (ex: the camera, the humidity sensor, a physical), the time of day, the weather forecast, other data or any combination thereof).

More specifically this new interactive audiovisual technique can be used to create any kind of application where a 3600 environment is required: an audio based story, an interactive film, an interactive graphic novel, a game, an educational project, or any simulative environment (i.e. car, simulator, plane simulator, boat simulator, medicine or healthcare simulator, environmental simulator like a combat simulator, crisis simulator or others).

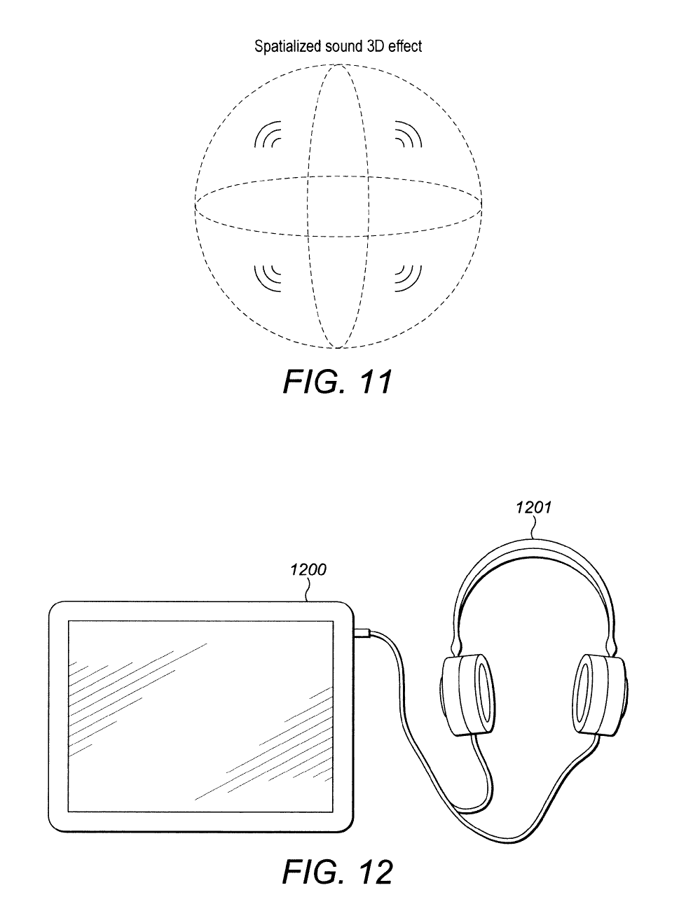

Some of the Gaze embodiments provide an improvement of surround 3D sound as the sound may be more dynamic as the Gaze technology adapts to the user's orientation in real-time and to the element in the 3D scenes viewed by the user. An illustration of spatialised sound is shown in FIG. 11 and may be delivered via a user device such as a tablet 1200 with stereo headphones 1201 as shown in FIG. 12.

It will be appreciated that the above embodiments may be deployed in hardware, software or a combination of both. The software may be stored on a non-transient computer readable medium, such as flash memory, or transmitted via a transient computer readable medium, such as network signals, for execution by one or more processors.

Potential advantages of some embodiments of the present invention is that simpler devices can be used to provide interactive virtual environments, the mechanism for providing interactivity is easier to use than prior art systems, application developers can more easier deploy varied interactivity within applications with virtual environment and novel interactive experiences are possible (e.g. where the user is not conscious of interacting).

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of providing interactivity within a virtual environment displayed on a device, including:
Receiving input from a user to orient a virtual camera within the virtual environment, wherein the virtual environment comprises a plurality of objects and wherein at least some of the objects are tagged; and
Triggering one or more actions associated with the tagged objects when the tagged objects are within a defined visual scope of the virtual camera.

2. A method as claimed in claim 1, further including:
Displaying a view from the virtual camera to the user on the device.

3. A method as claimed in claim 1, wherein at least one of the actions relates to the object.

4. A method as claimed in claim 1, wherein at least one of the actions is a visual change within the virtual environment.

5. A method as claimed in claim 4, wherein the visual change is an animation.

6. A method as claimed in claim 1, wherein at least one of the actions is an audio change within the virtual environment.

7. A method as claimed in claim 6, wherein the audio change is playback of an audio sample.

8. A method as claimed in claim 6, wherein the audio change is modification of a presently playing audio sample.

9. A method as claimed in claim 8, wherein the modification is reducing the volume of the presently playing audio sample.

10. A method as claimed in claim 6, wherein the audio change is localised within 3D space, such that the audio appears to the user to be originating from a specific location within the virtual environment.

11. A method as claimed in claim 1, wherein at least one of the actions changes the orientation of the virtual camera.

12. A method as claimed in claim 1, wherein at least one of the actions generates a user output.

13. A method as claimed in claim 12, wherein the user output is one selected from the set of audio, visual, and touch.

14. A method as claimed in claim 13, wherein the user output is vibration.

15. A method as claimed in claim 1, wherein at least one of the actions occurs outside the device.

16. A method as claimed in claim 1, wherein the virtual environment relates to interactive narrative entertainment.

17. A method as claimed in claim 16, wherein the interactive narrative entertainment is comprised of a branching narrative and wherein branches are selected by the user triggering at least one of the one or more actions.

18. A method as claimed in claim 1, wherein the visual scope is defined as a view formed by a ray projected from the virtual camera into the virtual environment.

19. A method as claimed in claim 18, wherein the tagged objects are within the visual scope when the ray intersects with the tagged object.

20. A method as claimed in claim 1, wherein the visual scope is defined as a view formed by a cone projected from the virtual camera into the virtual environment.

21. A method as claimed in claim 1, wherein the visual scope is defined as the entire view of the virtual camera.

22. A method as claimed in claim 1, wherein the device is a virtual reality headset.

23. A method as claimed in claim 1, wherein the device is a portable device.

24. A method as claimed in claim 23, wherein the portable device is a smartphone, tablet, or smartwatch.

25. A method as claimed in claim 1, wherein the user orients the virtual camera using accelerometers and/or gyroscopes within the device.

26. A method as claimed in claim 25, wherein orientation of the device corresponds to orientation of the virtual camera.

27. A method as claimed in claim 1, wherein the one or more actions are triggered when the tagged objects are within visual scope of the virtual camera for a predefined period of time to trigger.

28. A method as claimed in claim 27, wherein the predefined period of time to trigger is defined for each tagged object.

29. A method as claimed in claim 1, wherein at least one action is associated with a predefined period of time of activation, and, wherein once triggered, the at least one action is activated after the elapse of the period of time of activation.

30. A method as claimed in claim 1, wherein triggering of at least one of the one or more actions triggers in turn another action.

31. A method as claimed in claim 1, wherein the one or more actions associated with at least some of the tagged objects are only triggered when the virtual camera is within a proximity threshold in relation to the tagged object.

32. A system for providing interactivity within a virtual environment, including:
A memory configured for storing data for defining the virtual environment which comprises a plurality of objects, wherein at least some of the objects are tagged;
An input means configured for receiving input from a user to orient a virtual camera within the virtual environment;
A display configured for displaying a view from the virtual camera to the user; and
A processor configured for orienting the virtual camera in accordance with the input and for triggering one or more actions associated with tagged objects within the visual scope of the virtual camera.

33. A system as claimed in claim 32, wherein the input means is an accelerometer and/or gyroscope.

34. A system as claimed in claim 32, wherein the system includes an apparatus which includes the display and input means.

35. A system as claimed in claim 34, wherein the apparatus is a virtual reality headset.

36. A system as claimed in claim 34, herein the apparatus is a portable device.

37. Computer program code for providing interactivity within a virtual environment, including:
A generation module configured, when executed, to generate a plurality of tagged objects within a virtual environment and to associate one or more actions with each tagged object; and
A trigger module configured, when executed, to generate a projection from a virtual camera into the virtual environment, to detect intersections between the projection and visible tagged objects, and to trigger actions associated with the intersected tagged objects.

38. A computer readable medium configured to store the computer program code of claim 37.

39. A system for providing interactivity within a virtual environment, including:
A memory configured for storing a generation module, a trigger module, and data for defining a virtual environment comprising a plurality of objects;
A user input configured for receiving input from an application developer to create a plurality of tagged objects and one or more actions associated with each tagged object within the virtual environment; and
A processor configured for executing the generation module to create a plurality of tagged objects and one or more actions associated with each tagged object within the virtual environment and for compiling an application program incorporating the trigger module.

40. A computer readable storage medium having stored therein instructions, which when executed by a processor of a device with a display and input cause the device to perform the steps of the method as claimed in claim 1.

41. (canceled)
